(19) United States
(12) Patent Application Publication
(10) Pub. No.: US 2019/0263443 A1
(43) Pub. Date: Aug. 29, 2019

(54) BALL SCREW OF AN ELECTROMECHANICAL POWER STEERING SYSTEM HAVING AN INTEGRATED ANGULAR-CONTACT BALL BEARING

(71) Applicants: THYSSENKRUPP PRESTA AG, Eschen (LI); THYSSENKRUPP AG, Essen (DE)

(72) Inventors: András ILLÉS, Gams (CH); Wolfram RAITHER, Buchs (CH)

(73) Assignees: ThyssenKrupp Presta AG, Eschen (LI); thyssenkrupp AG, Essen (DE)

(21) Appl. No.: 16/309,543

(22) PCT Filed: Jun. 22, 2017
(86) PCT No.: PCT/EP2017/065361

§ 371 Date: Dec. 13, 2018

(30) Foreign Application Priority Data
Jun. 22, 2016 (DE) 10 2016 007 541.4

(51) Int. Cl. B62D 5/04; F16C 19/18; F16H 25/22

(52) U.S. Cl. CPC B62D 5/0448; F16H 2025/2096; F16H 25/2214; F16C 19/183

(57) ABSTRACT

An electromechanical power steering device, which may be used in a motor vehicle, may include a servomotor that drives an axially movable component via a ball nut that is mounted in a bearing such that the ball nut can be rotated in a housing. The ball nut may be engaged with a threaded spindle that is configured on the axially movable component. The bearing may be a double-row angular contact ball bearing with a single-part bearing inner ring. In some cases contact angles of the double-row angular contact ball bearing may be configured such that a supporting spacing other than zero is formed.

The present invention relates to an electromechanical power steering device having the features of the preamble of claim 1.

In electromechanical power steering devices, a torque is generated by an electric motor, which torque is transmitted to a gear mechanism, and the steering torque which is introduced by the driver is superimposed therein.

An electromechanical power steering device of the generic type has a servomotor which acts on a ball nut of a ball screw drive. The ball nut is in engagement via circulating balls with a ball screw which is arranged on the outer circumference of a rack which is part of a rack and pinion steering system. A rotation of the ball nut brings about an axial movement of the rack, as a result of which a steering movement of the driver is assisted. The ball screw drive is preferably coupled via a toothed belt to the electric motor.

The ball nut is mounted rotatably in a ball bearing in the steering housing. Forces which act on the rack outside the axis generate tilting moments of the rack which have to be absorbed by the bearing. Furthermore, the bearing is subject to temperature influences which, on account of the different coefficients of thermal expansion of the bearing shells and the steering housing, lead during operation, for example, to a formation of gaps in the region of the bearing seat or to damage of the components if they are not compensated for.

It is therefore known to use angular contact ball bearings for mounting the ball nut. Angular contact ball bearings can absorb high axial and tilting forces without being damaged. However, they can be manufactured only with high complexity and are therefore expensive.

Laid open specification US 2015/0183455 A1 discloses two angular contact ball bearings for mounting a ball nut of a ball screw drive. The bearings in each case have a bearing inner ring and bearing outer ring, between which balls are arranged. The two bearing outer rings are supported on one side on the housing in a sprung manner. It is disadvantageous here that a multiplicity of components are necessary which require installation space and cause costs.

It is an object of the present invention to specify an electromechanical power steering device with a ball screw drive, in the case of which the ball nut is mounted in a bearing, which has improved resistance to tilting and can transmit axial forces without requiring large installation space and generating high production costs.

Said object is achieved by an electromechanical power steering device having the features of claim 1. Further advantageous embodiments of the invention can be gathered from the subclaims.

Accordingly, an electromechanical power steering device is provided, for a motor vehicle, with a servomotor which drives an axially movable component via a ball nut which is mounted in a bearing such that it can be rotated in a housing, the ball nut being in engagement with a threaded spindle which is configured on the component, and the bearing being a double-row angular contact ball bearing with a one-part bearing inner ring. The bearing system becomes particularly resistant to tilting as a result of the arrangement of an angular contact ball bearing. The one-part bearing inner ring makes a compact configuration possible which is inexpensive to manufacture as a result of a reduced number of components.

It is preferred here that the contact angles of the double-row angular contact ball bearing are selected in such a way that a supporting spacing other than zero is configured.

Here, the contact angle is to be understood to mean the angle, at which the connecting lines intersect with the bearing axis, the connecting lines running, starting from the center point of the balls of the respective angular contact ball bearing, through the respective contact to the running face of the bearing inner ring. The intersection points of the connecting lines with the bearing axis of the two rows of the double-row angular contact ball bearing form the supporting spacing with respect to one another, measured on the bearing axis.

In the case where the balls are in double contact with the bearing inner ring, the bisector of the two contact connecting lines, which run through the respective contact and the respective center point of the ball.

Said supporting spacing preferably lies in a range of from at least one time the diameter of the balls of the angular contact ball bearing to three times the diameter of the balls of the angular contact ball bearing. It is to be preferred, however, to configure said supporting spacing in a range of from 1.5 times to 2.5 times and particularly preferably 2 times the diameter of the balls of the angular contact ball bearing. In the case where the two bearings of the angular contact ball bearing have different ball diameters, the smaller ball diameter is to be considered to be the standard.

The contact angles of the two rows of the double-row angular contact ball bearing are preferably identical, which simplifies the manufacturing process.

It is preferably provided that the bearing outer ring is of two-part configuration. The ball guiding means can therefore be arranged between the bearing outer rings, as a result of which the bearing becomes as compact as possible. In addition, it can be provided that a pulley wheel is connected directly and fixedly to the outer surface of the ball nut so as to rotate with it, which pulley wheel is likewise arranged between the bearing outer rings.

The one-part bearing inner ring is preferably formed by way of the ball nut.

The spacing along the bearing axis between the ball center points of the angular contact bearing is particularly preferably to be configured in a range of from at least 3 times to 5 times the ball diameter. It is to be preferred to configure said spacing in a range of 4.5 times the ball diameter of the angular contact bearing.

It can preferably be provided that the ball nut in each case has a circumferential recess at its ends on its outer circumferential face, which circumferential recess forms a ball raceway of one row of the double-row angular contact ball bearing.

In one preferred embodiment, the component is a rack of a rack and pinion steering mechanism.

In the following text, one exemplary embodiment of the present invention will be described using the drawings. Identical components or components with identical functions have identical designations. In the drawings:

FIG. 1 shows a diagrammatic illustration of an electromechanical power steering device with a ball screw drive,

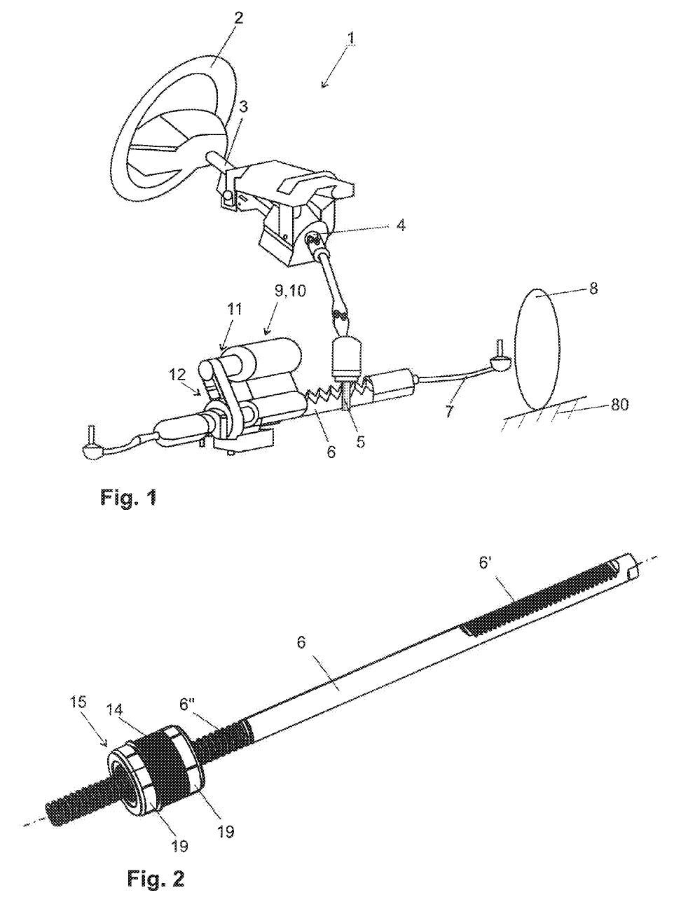

FIG. 2 shows a three-dimensional illustration of a ball screw drive according to the invention without the enclosing housing,

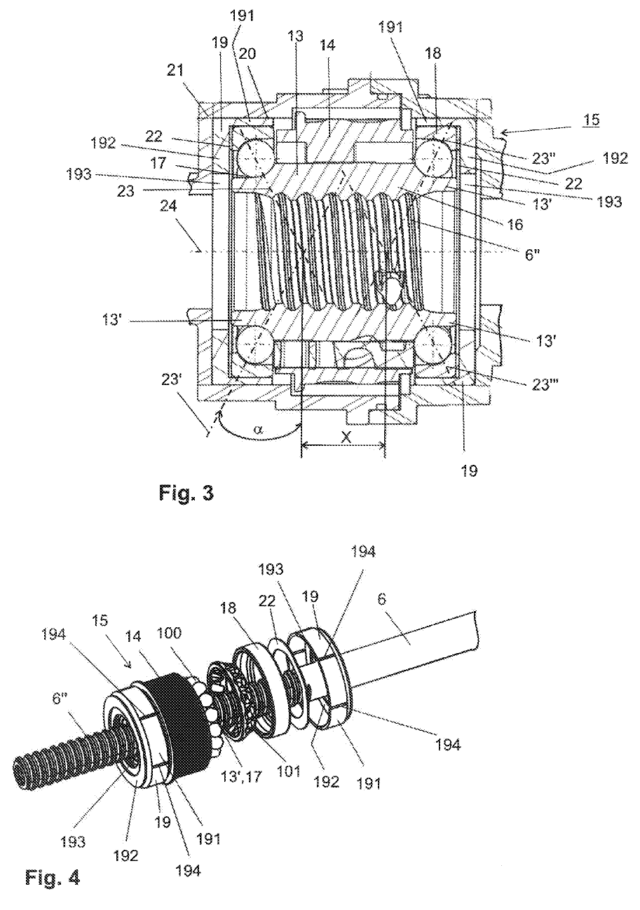

FIG. 3 shows a longitudinal section through an angular contact ball bearing of a power steering device according to the invention,

FIG. 4 shows a partially exploded illustration of the angular contact ball bearing in accordance with FIGS. 2 and 3,

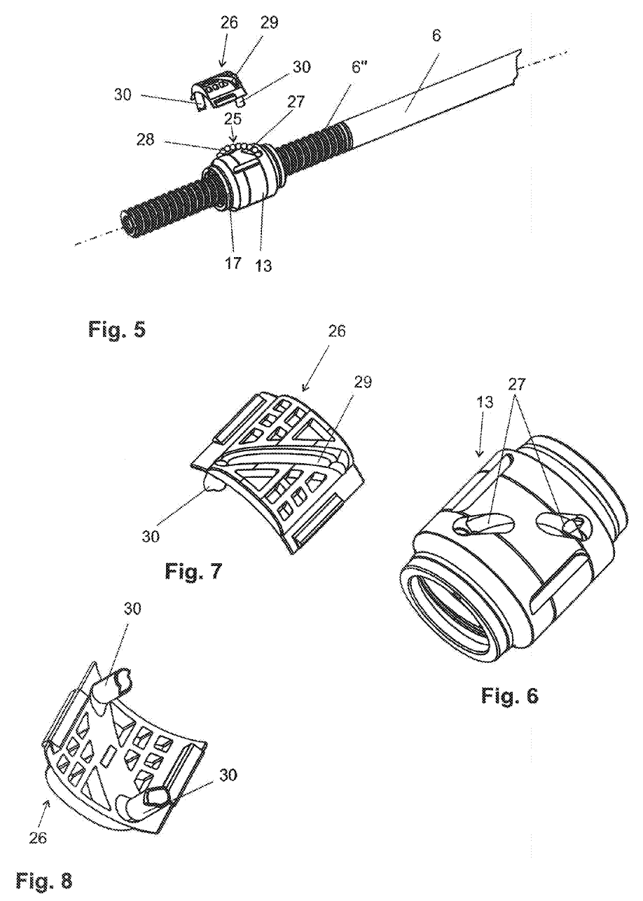

FIG. 5 shows a partially exploded illustration of the ball screw drive with a ball return means in accordance with FIGS. 2 and 3,

FIG. 6 shows a three-dimensional view of the ball nut,

FIG. 7 shows a three-dimensional illustration of the ball return means in a view from above, and

FIG. 8 shows a three-dimensional illustration of the ball return means in a view from below.

FIG. 1 diagrammatically shows an electromechanical motor vehicle steering device 1 with a steering wheel 2 which is coupled in a torque-proof manner to an upper steering shaft 3 and a lower steering shaft 4. The upper steering shaft 3 is functionally connected via a torsion bar to the lower steering shaft 4. The lower steering shaft 4 is connected in a torque-proof manner to a pinion 5. The pinion 5 meshes in a known way with a toothed segment 6′ of a rack 6. The rack 6 is mounted in a steering housing such that it can be displaced in the direction of its longitudinal axis. At its free ends, the rack 6 is connected to track rods 7 via ball joints (not shown). The track rods 7 themselves are connected in a known way via steering knuckles to in each case one steered wheel 8 of the motor vehicle. A rotation of the steering wheel 2 leads via the connection with the steering shaft 3, 4 and with the pinion 5 to a longitudinal displacement of the rack 6 and therefore to pivoting of the steered wheels 8. The steered wheels 8 experience a reaction via a roadway 80, which reaction counteracts the steering movement. As a consequence, a force is required to pivot the wheels 8, which force makes a corresponding torque on the steering wheel 2 necessary. An electric motor 9 of a servo unit 10 is provided, in order to assist the driver during said steering movement. To this end, the electric motor 9 drives a ball nut of a ball screw drive 12 via a belt drive 11. A rotation of the nut sets the threaded spindle of the ball screw drive 12, which threaded spindle is part of the rack 6, in an axial movement which ultimately brings about a steering movement for the motor vehicle.

Even if an electromechanical power steering device with a mechanical coupling between the steering wheel 2 and the steering pinion 5 is shown here in the example, the invention can also be applied to motor vehicle steering devices, in which there is no mechanical coupling. Steering systems of this type are known under the term steer-by-wire.

FIG. 2 shows the ball screw drive in three-dimensional form. The threaded spindle 6″ is part of the rack 6 and is arranged spaced apart from the toothed segment 6′. The ball nut 13 has a pulley wheel 14 on its outer circumferential face.

FIG. 3 shows the ball nut 13 and the threaded spindle 6″ in a longitudinal section. The ball nut 13 is mounted rotatably in a double-row angular contact ball bearing 15. The bearing 15 has a single common inner ring 16 which is formed by way of the ball nut 13. To this end, the ball nut 13 has in each case one circumferential recess 17 for a ball raceway at its ends 13′ on its outer circumferential face 16. Here, the recess 17 or the raceway profile is configured in accordance with an angular contact ball bearing 15. The raceway profile 17 and/or the sleeve of the angular contact ball bearing can be configured as an ogival profile, with the result that a punctiform contact is produced between the raceway and the balls 100. As a result, a uniform load distribution, a high rigidity and improved running properties with more accurate guidance are made possible. The balls preferably have a two-point contact between the recess 17 and the sleeve 19. There can further preferably be a four-point contact between the ends 13′ of the ball nut 13 and the sleeve. To this end, the end 13′ of the ball nut can be configured as a funnel shape.

Furthermore, the bearing 15 has in each case one outer ring 18. The outer rings 18 are received in each case in a separate sleeve 19 which is arranged in a bearing seat 20 of the housing 21. The pulley wheel 14 of the toothed belt drive 11 is fastened in a torque-proof manner on the ball nut 13. The sleeve 19 is preferably formed from a material which has a greater thermal expansion than aluminum and steel. In particular, the sleeve 19 is preferably formed from a plastic, particularly preferably from PA66GF30 (polyamide 66 with glass fiber reinforcement with a 30% volume share). The sleeve 19 is preferably manufactured from plastic and compensates for thermal expansions between the mechanism housing 21 and the ball nut drive 12.

The sleeve preferably comprises a circular-cylindrical circumferential wall 191 which encloses the bearing 15 and the bearing axis 24, and a circular-cylindrical bottom region 192 which extends radially inward in the direction of the bearing axis 24 and has a circular-cylindrical opening 193 which encloses the bearing axis 24. Here, the two separate sleeves 19 are preferably arranged in such a way that the two bearings 15 are arranged between the two bottom regions 192. The bottom regions 192 are preferably of planar configuration with a preferably constant thickness. It is also conceivable and possible, however, to provide the bottom regions in a targeted manner with grooves, engravings or ribs or an undulating shape, in order, for example, to influence the lubrication and/or the thermal properties in a targeted manner.

For further improvement of the compensation properties, the sleeve can have recesses in its circumferential wall 191, preferably slots 194 which extend in the direction of the bearing axis 24. Said slots preferably run as far as to that open end of the circumferential wall 191 which is directed away from the bottom region 192. In other words, the slots 194 are open in the direction of the pulley wheel 14.

The sleeve 19 is preferably formed in one piece from a single component, is preferably formed integrally from a single material, and is particularly preferably formed in an injection molding method.

As shown in FIG. 4, a corrugated spring 22 is arranged in the sleeve 19 in the preferred embodiment, which corrugated spring 22 prestresses the bearing 15 in the axial direction. The corrugated spring 22 lies between the sleeve 19 and the bearing outer ring 18. The attachment rigidity can be set by way of the combination of the sleeve 19 and the corrugated spring 22. In addition, said combination makes damping of the movement of the bearing 15 in the case of dynamic loads and reduction of load peaks possible.

Depending on the application, however, said corrugated spring 22 can be replaced by way of a cup spring or by way of a combination of a cup spring and a corrugated spring.

The balls 100 of the angular contact ball bearing 15 are guided in a ball cage 101.

The raceways of the double-row angular contact ball bearing 15 are configured in such a way that the connecting lines 23, 23′, 23″, 23′″ of the contact points between the ball and the raceways intersect the bearing axis 24 so as to lie between the outer rings 18. A predefined supporting spacing X is formed between the two intersection points with the bearing axis 24. The bearing 15 becomes particularly resistant to tilting as a result of the great supporting spacing X. For a particularly high tilting resistance, the supporting spacing X preferably lies in an interval between one time and three times the diameter of the balls 100 of the angular contact bearing. A supporting distance which corresponds to twice the diameter of the balls 100 of the angular contact ball bearing is to be particularly preferred. The contact area of the ball 100 on the raceway face 17 and an inner face of the sleeve preferably corresponds to a quarter of a ball circumferential area. An undercut which is not contacted by the ball preferably remains both on the raceway face and on the inner face of the sleeve. The angle which connecting line of the two contact points between the ball 100 and the raceways encloses with the radial plane and at which the loading is transmitted from one raceway to the other is called the contact angle α. The contact angle is preferably of equal magnitude for both rows of the bearing 15. The optimum tilting resistance of the bearing 15 can be set at a defined contact angle α by way of a predefined value of the supporting spacing X.

FIGS. 5 to 8 show the ball nut 13 and a ball return means 25 in detail. The details show the rack 6 with the ball screw 6″ and the ball screw drive which is arranged thereon without a pulley wheel.

FIG. 5 shows the ball nut 13 with a deflecting body 26 placed on it. On its inner side, the ball nut 13 bears a ball screw, in which balls roll in a manner known per se. The ball nut 13 has two through recesses 27. In each case one recess 27 is provided for the entry and exit of balls 28 for the external ball return means to the opposite end of the ball screw. The ball return means 25 which connects the two recesses 27 to one another is formed at least partially by way of the deflecting body 26. The ball return means 25 is of U-shaped configuration. The return channel is formed at least partially by way of a recess 29 in the deflecting body 26 and two pins 30 which adjoin it. The recess 29 is arranged diagonally over the deflecting body 26 which is adapted as an attachment on its inner side to the curvature of the upper side of the ball nut 13, and extends in the circumferential direction over a limited sector of the ball nut 13. As shown in FIG. 5, the deflecting body 26 is inserted by means of the pins 30 into the two recesses 27 of the ball nut 13, with the result that the ball return means 25 is connected to both ends of the ball screw.

The bearing 15 of the ball nut 13 is configured in such a way that the ball return means 25 and/or the deflecting body 26 can be arranged between the ball nut and the pulley wheel. The ball return means and/or the deflecting body therefore have/has space within the double-row bearing, as a result of which the arrangement becomes particularly compact.

The power steering device according to the invention therefore has a bearing which has an improved resistance to tilting in comparison with conventional bearings. It can transmit high axial forces and has a reduced number of components as a result of the inner ring which is integrated into the ball nut, which has a positive effect on the costs.

1.-9. (canceled)

10. An electromechanical power steering device for a motor vehicle comprising a servomotor that drives an axially movable component via a ball nut that is mounted in a bearing such that the ball nut is rotatable in a housing, wherein the ball nut is engaged with a threaded spindle that is configured on the axially movable component, wherein the bearing is a double-row angular contact ball bearing with a single-part bearing inner ring.

11. The electromechanical power steering device of claim 10 wherein contact angles of the double-row angular contact ball bearing are configured such that a supporting spacing other than zero is formed.

12. The electromechanical power steering device of claim 11 wherein the contact angles of the two rows of the double-row angular contact ball bearing are identical.

13. The electromechanical power steering device of claim 10 comprising a bearing outer ring of a two-part configuration.

14. The electromechanical power steering device of claim 10 comprising a pulley wheel that is connected directly and fixedly to an outer surface of the ball nut such that the pulley wheel rotates with the ball nut.

15. The electromechanical power steering device of claim 10 wherein a spacing between ball center points of the double-row angular contact ball bearing are in a range of at least 3 times to 5 times a ball diameter.

16. The electromechanical power steering device of claim 15 wherein each end of the ball nut has a circumferential recess on an outer circumferential face of the ball nut, wherein the circumferential recess forms a ball raceway of a row of the double-row angular contact ball bearing.

17. The electromechanical power steering device of claim 10 wherein the single-part bearing inner ring is formed by way of the ball nut.

18. The electromechanical power steering device of claim 10 wherein the axially movable component is a rack of a rack and pinion steering mechanism.
